(19) United States
(12) Patent Application Publication
(10) Pub. No.: US 2013/0043018 A1
(43) Pub. Date: Feb. 21, 2013

(54) ARRANGEMENT AND METHOD FOR WARMING OF COOLANT WHICH CIRCULATES IN A COOLING SYSTEM

(71) Applicant: Hans Wikström, Johanneshov (SE)

(72) Inventor: Hans Wikström, Johanneshov (SE)

(21) Appl. No.: 13/695,758

(22) PCT Filed: Apr. 12, 2011
(86) PCT No.: PCT/SE2011/050441

§ 371 Date: Nov. 1, 2012

(30) Foreign Application Priority Data
May 4, 2010 (SE) 1050444-7

(51) Int. Cl. G05D 23/00

(52) U.S. Cl. 165/299

(57) ABSTRACT

An arrangement and a method for warming coolant in a cooling system of a combustion engine for instance in vehicle: A control unit (22) assesses whether the coolant is at a lower temperature (T_{C}) than an operating temperature (T_{D}) and whether air flowing through the coolant cooler (18) is at a temperature (T_{A1}, T_{A2}) higher than the coolant's temperature (T_{C}). If the assessing determines that those conditions are satisfied, the control unit (22) places a valve (17) in a second position to lead the coolant to the coolant cooler (18), for warming the coolant by air flowing through the coolant cooler (18).

### BACKGROUND TO THE INVENTION AND PRIOR ART

The present invention relates to an arrangement and a method for warming of coolant which circulates in a cooling system according to the preambles of claims 1 and 11.

When heavy vehicles in particular are set in motion from cold, the coolant which cools the combustion engine takes a relatively long time to reach the desired operating temperature. This is a problem particularly in situations where a cold ambient temperature prevails. During the time when the coolant is at too low a temperature, the combustion engine will not run optimally, nor will the cab space intended to be warmed by the coolant receive any real warming.

In supercharged combustion engines the air is compressed before it is led to the combustion engine. The air thereby acquires a higher pressure and a higher temperature. The compressed air is cooled in at least one charge air cooler before it is led to the combustion engine. The technique called EGR (exhaust gas recirculation) is a known way of leading part of the exhaust gases from a combustion process in a combustion engine back to a line for supply of air to the combustion engine. Adding exhaust gases to the air causes a lower combustion temperature resulting inter alia in the exhaust gases having a reduced content of nitrogen oxides NOₓ. The recirculating exhaust gases are cooled in one or more EGR coolers before they are mixed with the air and led to the combustion engine.

A known practice is to cool the compressed air in charge air coolers and the recirculating exhaust gases in EGR coolers, which are situated ahead of the radiator for the coolant in the cooling system which cools the combustion engine. The compressed air and the recirculating exhaust gases will thus be cooled by air which is at the temperature of the surroundings, whereas the coolant is cooled by air which is at a higher temperature than the surroundings. This air is nevertheless usually at a definitely lower temperature than the coolant when it has reached its operating temperature. The coolant therefore undergoes good cooling even when the coolant cooler is situated downstream of a charge air cooler and/or an EGR cooler.

### SUMMARY OF THE INVENTION

The object of the present invention is to propose an arrangement and a method which make it possible for the coolant in a cooling system to be warmed quickly in a relatively simple way after starting of a combustion engine.

This object is achieved with the arrangement of the kind mentioned in the introduction which is characterised by the features indicated in the characterising part of claim 1. In this case, the coolant cooler of the cooling system is situated at a location in the vehicle where, during operation of the combustion engine, it has air flowing through it which is at a higher temperature than the surroundings. The vehicle may have a heat-generating component situated upstream of the coolant cooler. When a combustion engine has been switched off for a time, the coolant in the cooling system will be at substantially the same temperature as the surroundings. It is therefore possible to use this air which is at a higher temperature than the surroundings to warm the coolant in the coolant cooler after a cold start. In this situation the valve means is placed in the second position so that the cold coolant is circulated through the coolant cooler. The coolant circulating in the cooling system will thus be warmed by the warm air flowing through the coolant cooler. The coolant will thus be warmed both in the coolant cooler and by the combustion engine when it circulates in the cooling system. The coolant may be warmed in the coolant cooler until it is at substantially the same temperature as the air flowing through the coolant cooler. When the coolant reaches this temperature, the valve means is placed in the first position. The coolant is then led directly to the combustion engine. The present invention thus makes it possible to achieve rapid initial warming of the coolant by means of the coolant cooler. The period when the coolant is at a very low temperature in a vehicle being set in motion from cold can thus be considerably shortened.

According to an embodiment of the present invention, the valve means is a three-way valve situated in said manifold. The three-way valve is with advantage an electrically operated valve controlled by the control unit. When the control unit places the three-way valve in the first position, it leads the coolant to the first line, and when it places the three-way valve in the second position it leads the coolant to the second line. Alternatively, the cooling system may comprise a thermostat in said manifold and the valve means may be situated in the first line and adapted to leading the coolant from the first line to the second line via a connecting line when it is placed in the second position. In this case a conventional thermostat maintains the temperature of the coolant during normal operation. During the stage when the thermostat directs the coolant to the first line, the control unit assesses whether it is possible to warm the coolant in the coolant cooler. When this is possible, the control unit places the valve means in the second position so that the coolant is led to the coolant cooler.

According to another embodiment of the present invention, the control unit is adapted to receiving information from a temperature sensor which detects the temperature of the coolant in the cooling system. With advantage, the temperature sensor so located in the cooling system that it detects the temperature of the coolant close to said manifold. The control unit may be adapted to also receiving information from a temperature sensor situated at a location where it detects the temperature of the air reaching the coolant cooler. On the basis of such information the control unit can easily decide whether the air flowing through the coolant cooler is at a higher temperature than the coolant and whether it is usable to warm the coolant in the coolant cooler.

According to a preferred embodiment of the present invention, the arrangement comprises at least one cooler for cooling a gaseous medium which is led to the combustion engine, which cooler is situated at a location upstream of the coolant cooler so that the air flows through this cooler and cools the gaseous medium before the air flows through the coolant cooler. With such a cooler, the air reaching the coolant cooler will be at a definitely higher temperature than the surroundings. It is therefore possible to use this air to warm the coolant at an initial stage after a cold start. Said cooler may be a charge air cooler for cooling of compressed air which is led to the combustion engine. Air being compressed acquires a raised temperature which is related to the degree of compression of the air. The compressed air is cooled with the object of reducing its volume. In this case the thermal energy of the compressed air is utilised to warm the coolant during an initial stage after a cold start. Said cooler may alternatively be an EGR cooler for cooling of recirculating exhaust gases which are led to the combustion engine. The recirculating exhaust gases will be at a very high temperature and therefore need cooling before they are mixed with air and led to the combustion engine. In this case the thermal energy of the recirculating exhaust gases can be utilised to warm the coolant during an initial stage after a cold start. Said cooler may according to further alternatives be an air-cooled cooler for gearbox oil, motor oil or hydraulic oil or a condenser for an AC installation.

According to a preferred embodiment of the present invention, the control unit may be adapted to controlling the speed of a fan which creates the air flow through the coolant cooler. The air flow to the coolant cooler may be varied by controlling the speed of the fan. This makes it possible for the temperature of the air reaching the coolant cooler to be varied in a way which promotes rapid warming of the coolant. The control unit may also be adapted to controlling a coolant pump which circulates the coolant in the cooling system. The coolant flow through the coolant cooler may thus be varied in a way which promotes rapid warming of the coolant.

The above object is also achieved with the method of the kind mentioned in the introduction which is characterised by the features indicated in the characterising part of claim 11.

### BRIEF DESCRIPTION OF THE DRAWINGS

Preferred embodiments of the invention are described below by way of examples with reference to the attached drawings, in which:

FIG. 1 depicts an arrangement for warming of coolant in a cooling system according to a first embodiment,

FIG. 2 is a flowchart illustrating a method according to the invention and

FIG. 3 depicts an arrangement for warming of coolant in a cooling system according to a second embodiment.

### DETAILED DESCRIPTION OF PREFERRED EMBODIMENTS OF THE INVENTION

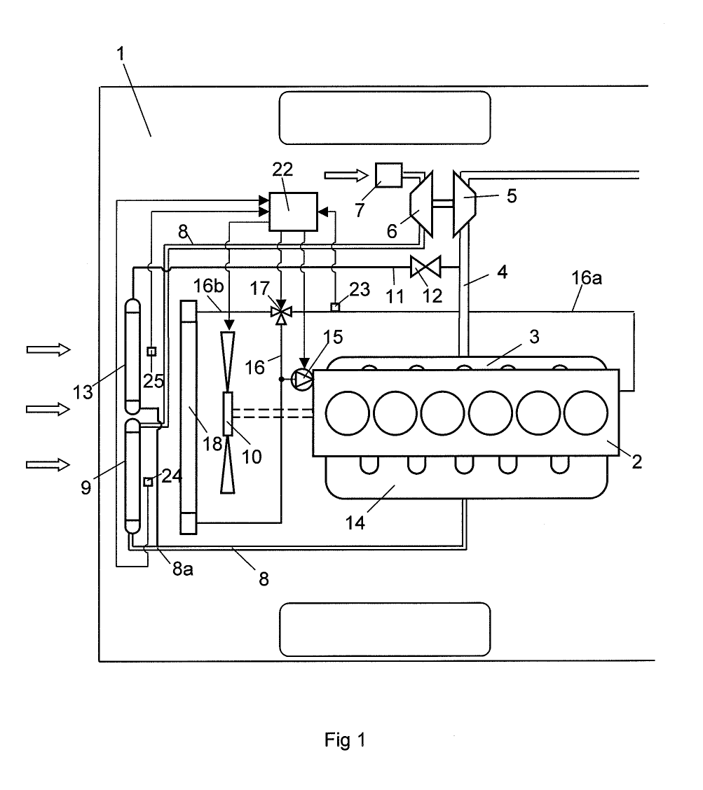

FIG. 1 depicts a vehicle 1 powered by a supercharged combustion engine 2. The vehicle 1 may be a heavy vehicle powered by a supercharged diesel engine. The exhaust gases from the cylinders of the combustion engine 2 are led to an exhaust line 4 via an exhaust manifold 3. The exhaust gases in the exhaust line 4, which will be at above atmospheric pressure, are led to a turbine 5 of a turbo unit. The turbine 5 is thus provided with driving power which is transferred, via a connection, to a compressor 6. The compressor 6 compresses air which is led into an air line 8 via an air filter 7. A charge air cooler 9 is provided in the air line 8. The charge air cooler 9 is arranged at a front portion of the vehicle 1. The purpose of the charge air cooler 9 is to cool the compressed air before it is led to the combustion engine 2. The compressed air is cooled in the charge air cooler 9 by air at the temperature of the surroundings which is caused to flow through the charge air cooler 9 by a cooling fan 10. The cooling fan 10 is driven by the combustion engine 2 via a suitable connection.

The combustion engine 2 is provided an EGR (exhaust gas recirculation) system for recirculation of the exhaust gases. Mixing exhaust gases with the compressed air which is led to the engine's cylinders lowers the combustion temperature and hence also the content of nitrogen oxides NOₓ formed during the combustion processes. A return line 11 for recirculation of exhaust gases extends from the exhaust line 4 to the air line 8. The return line 11 comprises an EGR valve 12 by which the exhaust flow in the return line 11 can be shut off. The EGR valve 12 may also be used to steplessly control the amount of exhaust gases led from the exhaust line 4 to the air line 8 via the return line 11. The return line 11 comprises an EGR cooler 13 to cool the circulating exhaust gases. In certain operating states of supercharged diesel engines 2, the pressure of the exhaust gases in the exhaust line 4 will be lower than the pressure of the compressed air in the inlet line 8. In such situations it is not possible to mix the exhaust gases in the return line 11 directly with the compressed air in the inlet line 8 without special auxiliary means. To this end it is for example possible to use a venturi or a turbo unit with variable geometry. If the combustion engine 2 is instead a supercharged Otto engine, the exhaust gases in the return line 11 can be led directly into the inlet line 8, since the exhaust gases in the exhaust line 4 of an Otto engine in substantially all operating situations will be at a higher pressure than the compressed air in the inlet line 8. After the exhaust gases have been mixed with the compressed air at a location 8a, they are led to the respective cylinders of the diesel engine 2 via a manifold 14.

The combustion engine 2 is cooled in a conventional way by a cooling system which contains a circulating coolant. A coolant pump 15 circulates coolant in the cooling system. The coolant pump 15 circulates the coolant initially through the combustion engine 2. After the coolant has cooled the combustion engine 2, it is led via a line 16 to a three-way valve 17 in the cooling system. The three-way valve 17 is situated in a manifold where the line 16 divides into a first line 16a which leads coolant to the combustion engine 2 and a second line 16b which leads coolant to a coolant cooler 18. The coolant cooler 18 is situated in a forward region of the vehicle 1 at a location downstream of the charge air cooler 9 and the EGR cooler 13 with respect to the intended direction of air flow in that region. Such positioning of the EGR cooler 13 and the charge air cooler 9 makes it possible for the recirculating exhaust gases and the compressed air to be cooled by air which is at the temperature of the surroundings while the air reaching the coolant cooler 18 situated behind them is at a higher temperature. As the coolant during normal operation is at a temperature of about 80-100° C., the air, even if it is at a raised temperature relative to the surroundings, achieves acceptable cooling of the coolant in the coolant cooler 18 during normal operation of the vehicle 1.

The three-way valve 17 is controlled by a control unit 22. The three-way valve 17 may be an electrically operated valve. The control unit 22 can place the three-way valve 17 in a first position whereby the coolant is led into the first line 16a which leads it to the combustion engine 2, and in a second position whereby the coolant is led into the second line 16b which leads it to the coolant cooler 18. The control unit 22 receives information from a first temperature sensor 23 which detects the temperature of the coolant at a location substantially immediately upstream of the three-way valve 17. The control unit 22 also receives information from a second temperature sensor 24 which detects the temperature T_{A1} of the air at a location between the charge air cooler 9 and the coolant cooler 18, and from a third temperature sensor 25 which detects the temperature T_{A2} of the air at a location between the EGR cooler 13 and the coolant cooler 18. The control unit 22 is adapted to controlling the operation of the cooling fan 10 so that a desired air flow is provided through the coolers 9, 13, 18. The control unit 22 is also adapted to controlling the operation of the coolant pump 15 so that a desired coolant flow is provided in the cooling system.

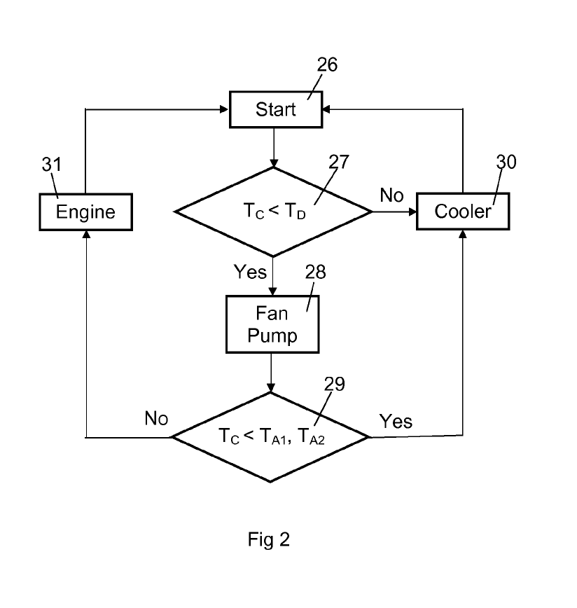

There follows with reference to the flowchart in FIG. 2 a description of how the coolant is warmed after a cold start of the combustion engine 2. The combustion engine 2 is started at step 26. When the combustion engine 2 is started, the coolant pump 15 is activated and starts circulating the coolant in the cooling system. The combustion engine's exhaust gases start the operation of the turbine 5 which drives the compressor 6. The compressor draws in and compresses air in the inlet line 8. The compressed air is led to the charge air cooler 9, in which it is cooled before it is led to the combustion engine 2. Part of the combustion engine's exhaust gases is recirculated through the return line 11. The recirculating exhaust gases are cooled in the EGR cooler 13 before they are mixed with the compressed air in the inlet line 8 and led to the combustion engine 2. The combustion engine activates the cooling fan 10 to draw a cooling air flow through the charge air cooler 9 and the EGR cooler 13. The air reaching the coolant cooler 18 thus acquires a raised temperature relative to the surroundings.

At step 27, the control unit 22 receives information from the first temperature sensor 23 concerning the coolant's temperature T_{C} before it reaches the three-way valve 17. The control unit 22 assesses whether the coolant's temperature T_{C} is lower than the coolant's desired operating temperature T_{D}. If the combustion engine 2 had been switched off for a time before being started, the coolant will be at a temperature corresponding to that of the surroundings. The coolant's temperature will therefore need to be raised to reach the operating temperature T_{D}. Particularly if the surroundings are at a low temperature, the coolant's temperature T_{C} will be considerably lower than the operating temperature T_{D}. At step 28, if the control unit 22 finds that the coolant's temperature is too low, it will control the cooling fan 10 to a speed such that the air flowing through the charge air cooler 9 and the EGR cooler 13 is warmed to a suitable temperature before it reaches the coolant cooler 18 situated downstream. However, the air flow should not be controlled in such a way that the compressed air and the recirculating exhaust gases respectively undergo unacceptable cooling in the charge air cooler 9 and the EGR cooler 13. At step 28, the control unit 22 also causes the coolant pump 15 to provide in the cooling system a coolant flow which promotes rapid warming of the coolant.

At step 29, the control unit 22 receives information from the second temperature sensor 24 concerning the temperature T_{A1} of the air after it has passed through the charge air cooler 9, and information from the third temperature sensor 25 concerning the temperature T_{A2} of the air after it has passed through the EGR cooler 13. At step 29, the control unit 22 assesses whether the air led to the coolant cooler 18 is at a temperature T_{A1}, T_{A2} which is higher than the coolant's temperature T_{C}. In this case, two temperatures T_{A1}, T_{A2} of the air led into the coolant cooler are thus detected. In this case a mean value may be calculated to see whether it is possible to warm the coolant in the coolant cooler 18. If the control unit 22 finds that this is possible, it will at step 30 place the three-way valve 17 in the second position so that the coolant is led to the second line 16b and the coolant cooler 18. As the air flowing through the coolant cooler will be at a higher temperature T_{A1}, T_{A2} than the coolant's temperature T_{C}, the coolant undergoes warming when it is led through the coolant cooler 18. In this case, the coolant thus receives extra warming in the coolant cooler 18 in addition to the warming which it receives in the combustion engine 2. This extra warming in the coolant cooler 18 means that the coolant will be warmed significantly more quickly to its operating temperature T_{D}. The process then starts again at step 26.

So long as the coolant at step 27 is at a lower temperature T_{C} than the operating temperature T_{D}, the control unit 22 controls the cooling fan 10 and the coolant pump 15 with the object of giving the air flowing through the coolant cooler 18 a temperature T_{A1}, T_{A2} which is higher than the coolant's temperature T_{C}. When the control unit 22 finds that this is no longer possible, it will at step 30 place the three-way valve, in the first position so that the coolant is led directly to the combustion engine 2. During continued operation, the coolant will only continue to be warmed by the combustion engine 2. After a time, the coolant reaches its operating temperature T_{D}. When the control unit 22 finds at step 27 that the coolant's temperature T_{C} has been exceeded, it will at step 30 place the three-way valve 17 in the first position. The coolant is then once again led through the coolant cooler 18. In this case, however, the air flowing through the coolant cooler 18 will be at a temperature T_{A1}, T_{A2} which is lower than the coolant temperature T_{C}. Cooling of the coolant is thus provided in the coolant cooler 18. During continued operation of the combustion engine 2, the control unit 22 controls the three-way valve so that the coolant maintains a substantially constant temperature T_{C} which corresponds to the operating temperature T_{D}.

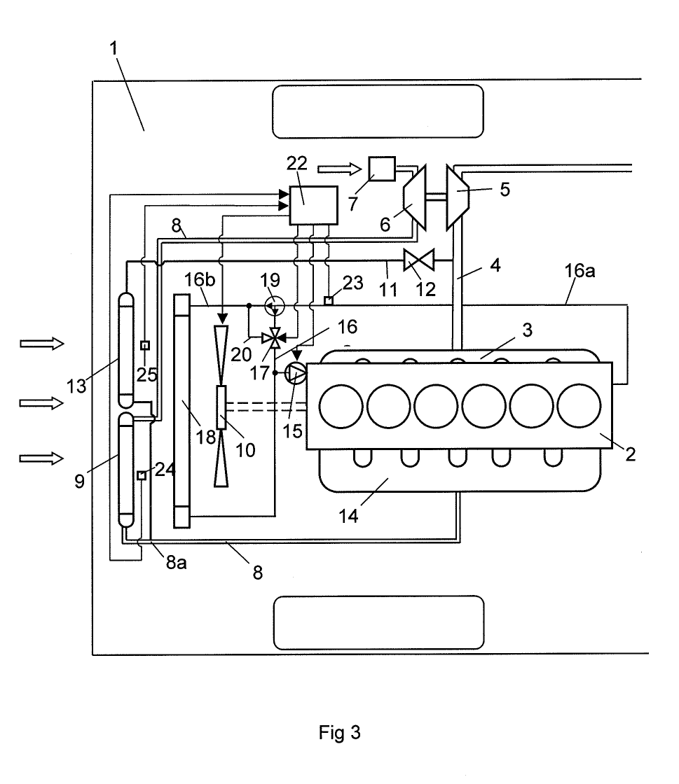

FIG. 3 depicts an alternative configuration. In this case a thermostat 19 is provided in the manifold which comprises the first line 16a and the second line 16b. The thermostat 19 is adapted in a conventional way to automatically direct the coolant to the first line 16a and the combustion engine 2 when the coolant is at a temperature T_{C} which is lower than a desired coolant temperature T_{D}, and to the second line 16b for cooling in the coolant cooler 18 when the coolant is at a temperature T_{C} which is higher than a desired cooling medium temperature T_{D}. The first line 16a is provided in this case with a three-way valve 17 which is controllable by a control unit 22. When the coolant's temperature T_{C} is lower than the operating temperature T_{D}, the thermostat 19 directs the coolant automatically into the first line 16a. The control unit 22 also reacts when the coolant's temperature T_{C} is lower than the operating temperature T_{D} at step 27. The control unit 22 then activates the cooling fan 10 and the coolant pump 15 with the object of maintaining a temperature difference the air and the coolant in the coolant cooler 18. At step 29, the control unit sees whether the air is at a temperature T_{A1}, T_{A2} which is higher than the coolant's temperature T_{C}. When such is the case, the control unit 22 will find that it is possible to warm the coolant in the coolant cooler 18 and will place the three-way valve 17 in the second position so that it leads coolant from the first line 16a to the second line 16b via a connecting line 20. The coolant is thus led to the coolant cooler 18, in which it is warmed by the air flowing through the coolant cooler 18.

When the coolant temperature T_{C} has risen to a similar level to the air, it is no longer possible to warm the coolant in the coolant cooler 18. The control unit 22 then places the three-way valve 17 in the first position so that the coolant is led to the combustion engine 2. During continued operation of the combustion engine 2, the coolant's temperature T_{C} rises until it exceeds the operating temperature T_{D}. When this happens, the thermostat 19 automatically resets itself so that it directs the coolant into the second line 16b for cooling in the coolant cooler 18. The thermostat 19 will continue to control the coolant flow so that the coolant maintains a temperature T_{C} which corresponds to the operating temperature T_{D}.

The invention is in no way limited to the embodiments to which the drawings refer but may be varied freely within the scopes of the claims. In the above examples, both a charge air cooler and an EGR cooler are situated in front of the coolant cooler. It is sufficient for only one such cooler or some other heat-generating element to be provided in front of the coolant cooler. Such an alternative heat-generating element may be an air-cooled cooler for gearbox oil, motor oil or hydraulic oil or a condenser for an AC installation.

1. An arrangement for warming of coolant in a cooling system which cools a combustion engine;
wherein the cooling system comprises a coolant cooler at a location where the coolant cooler has air flowing through the coolant cooler at a temperature (T_{A1}, T_{A2}) which is higher than the temperature of surroundings of the arrangement;
a manifold which comprises a first line which leads the coolant to the combustion engine and a second line which leads the coolant to the coolant cooler;
a valve operable into a first position in which the valve leads the coolant to the first line to the combustion engine and into a second position in which the valve leads the coolant to the second line to the coolant cooler;
the arrangement comprises a control unit configured for assessing whether the coolant in the cooling system is at a lower temperature (T_{C}) than an operating temperature (T_{D}) and whether the air flowing through the coolant cooler is at a temperature (T_{A1}, T_{A2}) which is higher than the coolant's temperature (T_{C}), and, if these conditions are fulfilled, the control unit is configured for placing the valve into the second position so that the coolant is led to the coolant cooler in which the coolant is warmed by the air which flows through the coolant cooler.

2. An arrangement according to claim 1, wherein the valve is a three-way valve situated in the manifold.

3. An arrangement according to claim 2, wherein the cooling system further comprises a thermostat situated in the manifold, the valve is situated in the first line and the valve is a three-way valve configured for leading the coolant from the first line to the second line via a connecting line when the valve is placed in the second position.

4. An arrangement according to claim 1, further comprising a temperature sensor configured for detecting the coolant temperature (T_{C}) in the cooling system, and wherein the control unit is configured for receiving information from the temperature sensor in order to assess the coolant temperature in the cooling system.

5. An arrangement according to claim 1, further comprising a temperature sensor situated at a location where it detects the temperature (T_{A1}, T_{A2}) of the air which flows into the coolant cooler; and
the control unit is configured for receiving information from the temperature sensor in order to assess the coolant temperature in the cooling system.

6. An arrangement according to claim 1, further comprising at least one second cooler for cooling a gaseous medium which is led to the combustion engine, the second cooler is situated at a location upstream of the coolant cooler so that the air flows through the second cooler and cools the gaseous medium before the air flows through the coolant cooler.

7. An arrangement according to claim 6, wherein the second cooler is a charge air cooler for cooling compressed air which is the gaseous medium led to the combustion engine.

8. An arrangement according to claim 7, wherein the second cooler further comprises an EGR cooler for cooling recirculating exhaust gases which are led to the combustion engine.

9. An arrangement according to claim 1, further comprising a fan configured and operable to force air flow through the coolant cooler, and the control unit is configured and operable for controlling the speed of the fan.

10. An arrangement according to claim 1, further comprising a coolant pump configured and operable for circulating the coolant in the cooling system, and the control unit is controlling the coolant pump.

11. A method for warming of coolant in a cooling system which cools a combustion engine wherein:
the cooling system comprises:
a coolant cooler situated at a location where the coolant cooler has air flowing through it at a temperature (T_{A1}, T_{A2}) which is higher than the temperature of the surroundings;
a manifold which comprises a first line which leads the coolant to the combustion engine and a second line which the leads coolant to the coolant cooler; and
a valve which is operable into a first position in which it leads coolant to the combustion engine and is operable into a second position in which it leads coolant to the coolant cooler;
the method comprises:
assessing whether the coolant in the cooling system is at a temperature (T_{C}) which is lower than an operating temperature (T_{D}) and assessing whether the air flowing through the coolant cooler (18) is at a temperature (T_{A1}, T_{A2}) which is higher than the coolant's temperature (T_{C}); and
if these conditions are fulfilled, placing the valve into the second position so that the coolant is led to the coolant cooler, in which the coolant is warmed by the air flowing through the coolant cooler.

12. An arrangement according to claim 6, wherein the second cooler comprises an EGR cooler for cooling recirculating exhaust gases which are led to the combustion engine.
